(19) United States
(12) Patent Application Publication
(10) Pub. No.: US 2023/0393568 A1
(43) Pub. Date: Dec. 7, 2023

(54) AUTOMATED RENDERING OF DATA FLOW ARCHITECTURE FOR NETWORKED COMPUTER SYSTEMS

(71) Applicant: Micron Technology, Inc., Boise, ID (US)

(72) Inventor: Jonathan Blaine Nielsen, Boise, ID (US)

(21) Appl. No.: 17/830,780

(22) Filed: Jun. 2, 2022

(51) Int. Cl. G05B 19/418

(52) U.S. Cl. CPC G05B 19/41885; G05B 19/41845; G05B 19/41875

(57) ABSTRACT

Systems, methods, and apparatus related to networked computer systems. In one approach, a central server collects tag data from computer systems on a network. The tag data is associated with processes that execute on the computer systems. The tag data includes source, destination, and data flow information for each process. The collected tag data is stored in a central data repository. The collected tag data is used to generate a data flow model. In one example, the data flow model is a system context diagram that indicates data transfers among the networked computer systems.

### FIELD OF THE TECHNOLOGY

At least some embodiments disclosed herein relate to networked computer systems in general, and more particularly, but not limited to rendering data flow architectures based on data collected from networked computer systems.

### BACKGROUND

A data architecture is sometimes used to represent or describe the use of data in a computing system. For example, the data architecture may describe a model of data interactions between various computer systems. In some cases, a data architecture describes data structures used by applications software that runs on computer systems. Examples of information in a data architecture may include descriptions of data stores, data groups, data items, and mappings of data to applications. In some cases, a data architecture may describe how data is processed, stored, and used in an information system. The data architecture may be represented in a data flow model.

In one example, a data flow model represents flows of data through computer processes or systems. In one example, the model provides information about the inputs and outputs of various computer systems that are networked together. For each data flow, at least one of the endpoints (e.g., source and/or destination) exists in a process.

### BRIEF DESCRIPTION OF THE DRAWINGS

The embodiments are illustrated by way of example and not limitation in the figures of the accompanying drawings in which like references indicate similar elements.

FIG. 1 shows various computing devices connected by a communication network, in accordance with some embodiments.

FIG. 2 shows a computer system storing tag data collected from various networked computer systems, in accordance with some embodiments.

FIG. 3 shows an exemplary database storing tag data associated with various processes, in accordance with some embodiments.

FIG. 4 shows a manufacturing server that controls machines used to manufacture a physical product, in accordance with some embodiments.

FIG. 5 shows an example of tags associated with stored procedures, in accordance with some embodiments.

FIG. 6 shows an example of a data flow model, in accordance with some embodiments.

FIG. 7 shows a block diagram of a computing device, which can be used in various embodiments.

FIG. 8 shows a block diagram of a computing device having a communication device, according to one embodiment.

FIG. 9 shows a method for rendering a data flow model based on data collected from tags associated with processes running on various computer systems, in accordance with some embodiments.

### DETAILED DESCRIPTION

The following disclosure describes various embodiments for rendering data flow architectures (e.g., a data flow model) based on data collected from networked computer systems. In one example, the data is collected from tags associated with processes that run on the computer systems. The tags provide data regarding data flows between the computer systems, and the collected data is used to generate a data flow model (e.g., a system context diagram).

Modern manufacturing and logistics operations are supported by numerous computer systems. These systems run various types of stored procedures (e.g., jobs), each having particular data requirements and specifications, yet each system typically needs to share some data with one or more other systems. Due to the complexity of the data interactions between these systems, it is difficult to make modifications to the software and/or hardware of one system without causing unexpected problems in other systems (e.g., due to unforeseen adverse ramifications as effects from a software change propagate through computer systems in a network). These problems can lead to system failures during manufacture and/or transport of a product or components for making a product. For example, the failures may result in defective product that must be destroyed. Thus, it is desirable to improve the analysis and assessment of these complex computer system interactions to avoid unexpected system failures or breakdowns.

Attempts to address these problems sometimes include the use of system context diagrams and/or training. System context diagrams illustrate data flows or transfers in networked computer systems. System context diagrams can be used for integration and regression testing prior to software releases. These diagrams identify inputs and outputs from systems so that cross-system impacts to changes (e.g., software updates or revisions) can be identified. However, these diagrams are typically created manually, and quickly become outdated.

Regarding training, the complexity of manufacturing and/or supply chain processes and limited cross-system expertise among IT staff makes it difficult for new hires to be trained. There may sometimes be manually documented processes available to use in training, but typically these manual efforts don't sufficiently identify or describe the relevant systems (e.g., the inputs and outputs of the processes running on the systems).

To address the above and other technical problems, tags are used to collect data from computer systems in a network. The collected data is used to render a data flow model (e.g., a system context diagram in printed or electronic form). In one embodiment, automated, self-updating system context diagrams are generated. These diagrams improve the testing of new software changes and/or aid in training.

In one example, various computer systems use jobs to import and export data. These jobs can be tagged to identify data being transferred by the job, and the systems involved in the data transfer. The tags are used to collect the data needed to render or generate the system context diagram. In one example, imports and exports are tagged with data regarding a source system (e.g., SAP ECC), data (e.g., Sales Orders), and a destination system (e.g., RapidResponse).

A central system that generates the system context diagram can run a job that collects data from other computer systems, and then writes the collected data (e.g., records of corresponding sets of source system, data, and destination system) to a central location. Then, for example, graphing software (e.g., iGrafx, Graphviz) can be used to create (e.g., draw) system connections and data flowing across the systems (e.g., through the imports/exports of each system). The graphing software can generate a system context diagram that illustrates the foregoing (e.g., for training purposes).

In one embodiment, a central computer system is used to collect data from tags associated with processes (e.g., stored procedures or jobs) running on other computer systems (e.g., various computing devices in a networked manufacturing IT system). In one example, the central computer system includes a data repository to store data collected from a plurality of networked computing devices. The computer system further includes a rendering component to generate a data flow model. The computer system has one or more processors that are used to query each of the plurality of networked computing devices to determine data flows by collecting data from tags associated with processes that execute on the computing devices. Each process is associated with a respective tag, and the tag includes a source, a destination, and a corresponding data flow.

The computer system stores, in the data repository, the data collected from the tags. The collected data includes the source, destination, and data flow for each respective process.

Then, the computer system generates, using the rendering component and based on the collected data from the tags, the data flow model. In one example, the data flow model is a system context diagram that is generated by graphing software that uses the data collected from the tags as inputs.

Various advantages are provided by at least some embodiments described herein. In one example, automating the creation and/or maintenance of system context diagrams by linking the diagrams to system import/export jobs will ensure that the diagrams can be readily generated and be up to date. In one example, automatically creating system context diagrams and/or providing links to information on various process diagrams can provide an improved learning environment.

In other examples, fewer bugs are released to production, timelines are shorter to train new hires, less work is required to create system context diagrams as this is no longer done manually, and system context diagrams can be readily kept up to date. Information technology (IT) support groups see a benefit in mapping out system integration dependencies.

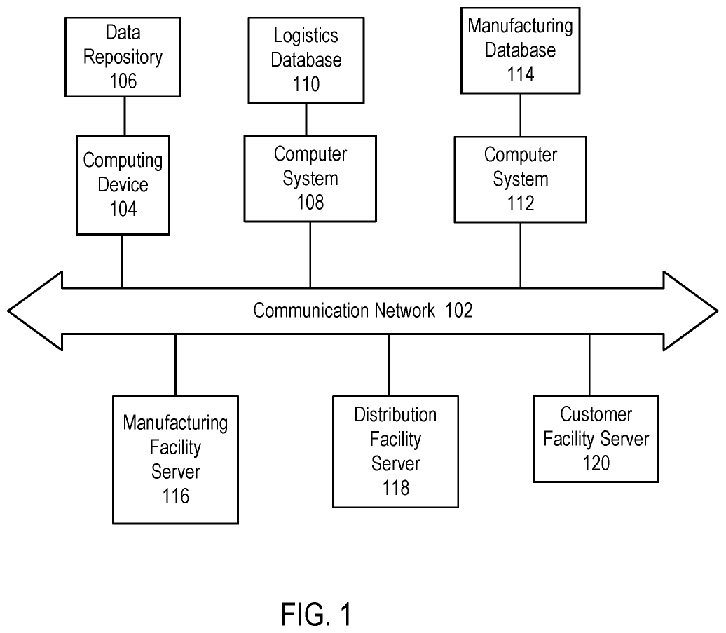

FIG. 1 shows various exemplary computing devices connected by a communication network 102, in accordance with some embodiments. In FIG. 1, a computing device 104 can be used to access, communicate with, and/or interact with computer system 108, computer system 112, manufacturing facility server 116, distribution facility server 118, and/or customer facility server 120 over communication network 102 (e.g., the Internet, a wide area network, a local network, or other wired or wireless communications network). In one example, computer systems 108, 112 are implemented using one or more computing devices. In one example, computer systems 108, 112 are implemented as servers.

Computing device 104 queries one or more of the computing devices on communication network 102 to collect tag data. In one example, computing device 104 queries each of computer systems 108, 112 to collect data from tags associated with jobs that run on computer systems 108, 112. In one example, a first job that runs on computer system 108 pulls data from manufacturing database 114 (a source of data) and stores the data in logistics database 110 (a destination for data). The tag data collected by computing device 104 includes information regarding a source, data flow, and destination for the foregoing data pulled by the first job. The data flow provides one or more characteristics of the data such as data type, format, etc. Computing device 104 can query servers 116, 118, 120 to collect similar data.

In one embodiment, manufacturing facility server 116 handles data related to manufacturing a product. In one example, the product (e.g., a memory device for an automobile) is manufactured using a manufacturing process controlled by server 116. In some cases, the product is a sample to be made and approved by a customer prior to volume manufacture of a commercial product.

The tag data collected by computing device 104 is stored in data repository 106. In one example, data repository 106 is a data warehouse, datastore, data store, file, and/or database used to store data for later use. In one example, data repository 106 persistently stores collected tag data in one or more databases, and/or other files. In one example, data repository 106 is implemented using distributed data stores.

In one embodiment, manufacturing database 114 and/or server 116 store specifications used to make a product in a manufacturing process. In one example, the specifications are parameters related to processing conditions for manufacture by a manufacturing machine. In another example, the parameters relate to the operation of the manufacturing machine. In one example, the obtained parameters control a chemical or other processing condition associated with the manufacturing machine. In another example, the specifications are related to a testing process (e.g., quality control test) used after manufacturing the physical product.

In one embodiment, the manufactured physical product is shipped to a distribution facility having distribution facility server 118. For example, server 118 obtains parameters from server 116, computer system 108, and/or computer system 112 used to handle logistics for the physical product. For example, the obtained parameters can be used to determine how to ship or otherwise provide the physical product to a customer facility having customer facility server 120.

In one example, distribution facility server 118 can transmit a communication to customer facility server 120 based on parameters obtained from scanning an encoded image (e.g., QR code) on the physical product. In another example, server 118 can receive a communication from server 116 regarding data associated with a characteristic of the physical product during manufacture (e.g., defect rate, test results, process conditions used during actual manufacture, etc.).

In one embodiment, the manufactured physical product is a silicon wafer. Each silicon wafer is processed using a manufacturing process controlled by server 116 and/or system 112. In one example, each wafer receives a unique laser scribe (e.g., for product traceability). Packaging and/or documents associated with the wafer include an encoded image (e.g., QR code) corresponding to the laser scribe.

In various examples, communication network 102 can include at least a local to device network such as Bluetooth or the like, a wide area network (WAN), a local area network (LAN), the Intranet, a mobile wireless network such as 4G or 5G, an extranet, the Internet, and/or any combination thereof. Nodes of a networked system of computing devices (e.g., mobile devices, servers, etc.) can each be a part of a peer-to-peer network, a client-server network, a cloud computing environment, or the like. In one example, a computer system operates in the capacity of a server or a client machine in a client-server network environment, as a peer machine in a peer-to-peer (or distributed) network environment, or as a server or a client machine in a cloud computing infrastructure or environment.

In one example, computing device 104 is a computing device such as a desktop computer, laptop computer, tablet, PDA, mobile phone, IoT device, or in-vehicle device. Computing device 104 may include one or more input devices or interfaces for a user of the computing device. For example, the one or more input devices or interfaces may include one or more of: a keyboard, a mouse, a trackpad, a trackball, a stylus, a touch screen, a hardware button of the client computing device, and the like. The computing device may be configured to execute various applications (e.g., a web browser application) to access the network.

In one example, each computer system or server may be any computing device configured to host one or more applications/services. In some embodiments, the server may require security verifications before granting access to the services and/or resources provided thereon. In some embodiments, the applications/services may include online services that may be engaged once a device has authenticated its access. In some embodiments, the server may be configured with an authentication server for authenticating users and/or devices. In other embodiments, an authentication server may be configured remotely and/or independently from the server.

In one example, the computer systems and/or servers may communicate with each other in a cloud system using a network (e.g., network 102). The network may be any type of network configured to provide communication between components of the cloud system. For example, the network may be any type of network (including infrastructure) that provides communications, exchanges information, and/or facilitates the exchange of information, such as the Internet, a Local Area Network, Wide Area Network, Personal Area Network, cellular network, near field communication (NFC), optical code scanner, or other suitable connection(s) that enables the sending and receiving of information between the components of the cloud system. In other embodiments, one or more components of the cloud system may communicate directly through a dedicated communication link(s).

In various embodiments, the cloud system may also include one or more cloud components. The cloud components may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.). In some embodiments, either one or both of the provider server and the authentication server may be configured to operate in or with cloud computing/architecture such as: infrastructure a service (IaaS), platform as a service (PaaS), and/or software as a service (SaaS).

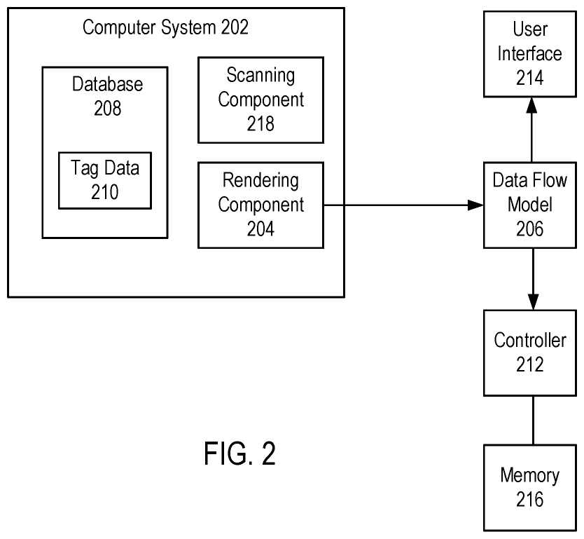

FIG. 2 shows a computer system 202 storing tag data 210 collected from various networked computer systems, in accordance with some embodiments. Computer system 202 is an example of computing device 104 of FIG. 1. In one example, the networked computer systems include one or more of computer systems 108, 112, or servers 116, 118, 120.

Computer system 202 collects tag data 210 by querying one or more of the networked computer systems. In one embodiment, the particular networked computer systems that will actually be queried can be identified or configured (e.g., defined in a table or list) by computer system 202. The collected tag data 210 is stored in database 208. Database 208 is an example of data repository 106.

In one embodiment, tag data 210 is collected by scanning component 218. In one example, scanning component 218 is a stored procedure that executes on computer system 202. In one example, scanning component 218 is a data scraper. Scanning component 218 can be configured to periodically query other computer systems at defined time intervals.

In one example, scanning component 218 is a job that collects tag data and stores the collected data in a centralized table of database 208. In one example, rendering component 204 is graphing software that reads records from the centralized table and creates a context diagram.

After tag data 210 is collected, rendering component 204 generates data flow model 206. In one example, data flow model 206 is a system context diagram. In one example, rendering component 204 is graphing software that uses numerous records of associated source, destination, and data flow information as inputs to generate a data flow model.

In one embodiment, data flow model 206 is a machine learning model. In one example, data flow model 206 is an artificial neural network. Rendering component 204 uses tag data 210 to train the artificial neural network.

In one embodiment, data flow model 206 is presented on user interface 214. In one example, user interface 214 is a display on a mobile device. In one example, user interface 214 is used for training a new hire.

In one embodiment, data flow model 206 is used as an input by controller 212. In one embodiment, data flow model 206 is stored in memory 216 of controller 212. In one example, controller 212 controls a manufacturing machine or other equipment that is used to manufacture a physical product. In one example, controller 212 is configured as manufacturing facility server 116. In one example, controller 212 is a microprocessor integrated into a manufacturing machine.

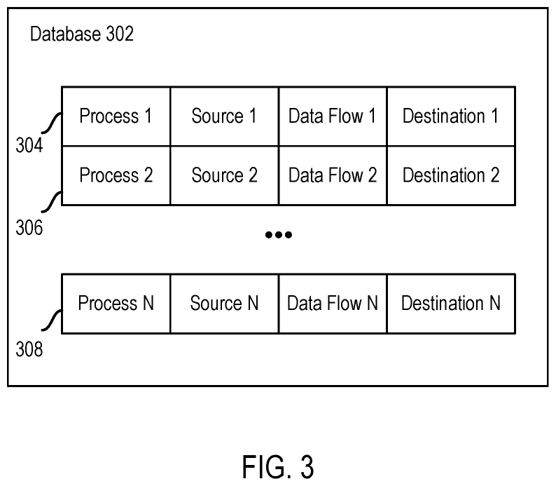

FIG. 3 shows an exemplary database 302 storing tag data associated with various processes, in accordance with some embodiments. In one example, the stored tag data is tag data 210. Database 302 is an example of database 208.

Database 302 includes multiple records 304, 306, 308. Each record corresponds to a process executing on one of various computer systems that are queried to collect the tag data. For example, record 304 corresponds to Process 1 (e.g., Process 1 is a job that executes on computer system 108, 112). Record 304 includes information regarding a source of data, a destination for the data, and a data flow that describes the data. Records 306, 308 include similar information.

In one embodiment, the data flow provides information regarding one or more characteristics of the data transferred from the source to the destination. In one example, the characteristics include a type of data, a data structure, and/or information regarding a network connection between the source and destination.

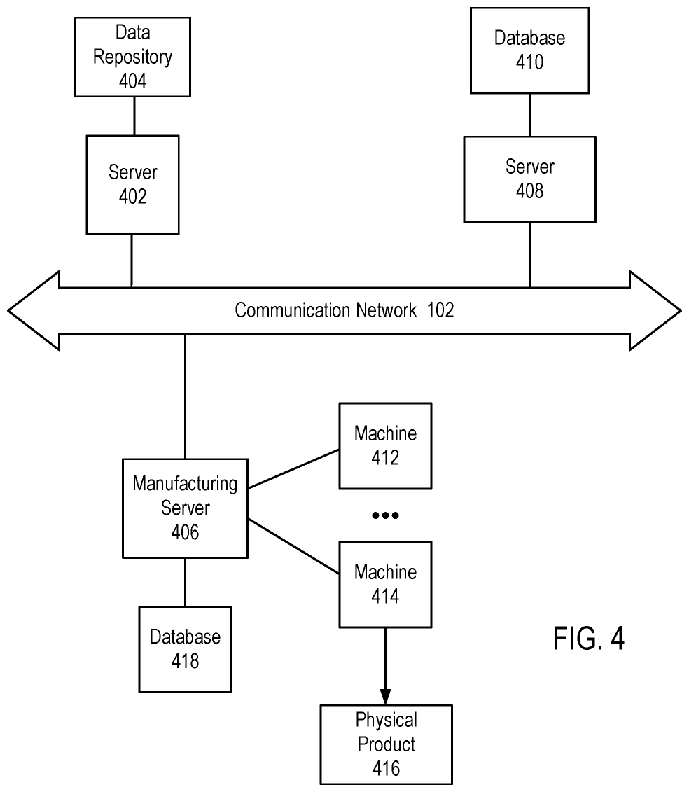

FIG. 4 shows a manufacturing server 406 that controls machines 412, 414 used to manufacture a physical product 416, in accordance with some embodiments. Manufacturing server 406 is an example of manufacturing facility server 116 or controller 212. Manufacturing server 406 communicates with servers 402, 408 over communication network 102.

In one example, physical product 416 is a memory device manufactured by processing a semiconductor wafer through multiple stages of processing. In one example, the machine 412, 414 is photolithography equipment and/or a chemical deposition machine.

Manufacturing server 406 runs various processes that store and/or use data in database 418. In one example, a first process on manufacturing server 406 communicates with server 408. In one example, the first process pulls data from database 418 (a source of data) and sends the data to database 410 (a destination of data) at server 408. In another example, a second process on server 408 requests data from database 418 (a source of data) and stores the data in database 410 (a destination of data).

In one example, database 410 stores data regarding components and/or materials used to manufacture physical product 416. In one example, server 408 communicates with manufacturing server 406 regarding availability of components and/or materials needed to manufacture physical product 416.

Server 402 collects tag data associated with processes that run on manufacturing server 406 and/or server 408. For example, server 402 collects tag data associated with the first process on manufacturing server 406 above and/or the second process on server 408 above. In one example, the collected tag data is tag data 210. Server 402 is an example of computing device 104 or computer system 202.

Server 402 stores the collected tag data in data repository 404. Data repository 404 is an example of data repository 106 or database 208.

Server 402 generates a data flow model using the collected tag data. In one example, the data flow model is data flow model 206.

In one embodiment, the generated data flow model is sent to manufacturing server 406. In one example, server 406 downloads the data flow model into one or more of machines 412, 414 (e.g., downloads firmware to configure a controller 212 of the machine). The downloaded data flow model is used to control machine 412 and/or 414 during manufacture of physical product 416.

In one example, the data flow model generated by server 402 is an artificial neural network. In one example, the artificial neural network is downloaded to machines 412 and/or 414.

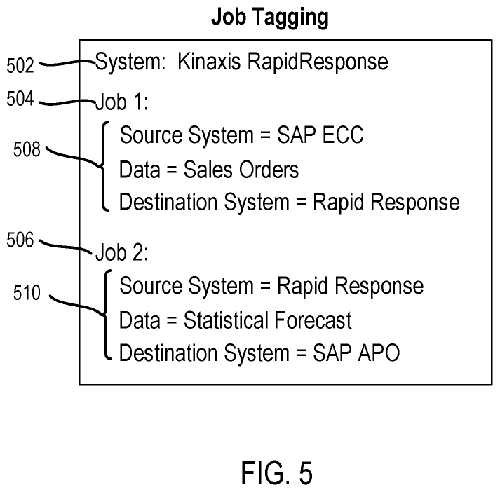

FIG. 5 shows an example of tags associated with stored procedures, in accordance with some embodiments. As illustrated, processes 504, 506 run on computer system 502. Each process 504, 506 is associated with a tag 508, 510. Tags 508, 510 are an example of tag data 210. Tags 508, 510 are an example of tag data stored in records 304, 306, 308.

For example, tag 508 indicates a source of data, a data flow, and a destination. In this example, the data flow of tag 508 is a type of data (sales orders).

For example, tag 510 indicates a source and destination of data being transferred. In this example, the data flow of tag 510 is a type of data (statistical forecasts).

In some embodiments, tag 508 or 510 may include a data flow that indicates a data structure of data being transferred. In one example, the data structure indicates a hierarchy of different types and/or formats of data being transferred.

In one embodiment, a naming convention used in tags (e.g., 508, 510) is aligned for systems and data. This is so that the naming used in tags is consistent across multiple computer systems that will be queried. In one example, a document or other lookup source is used (e.g., stored on computing device 104) to define naming for systems and data so that alignment is maintained. In one example, the document or other lookup source is stored on computer system 202.

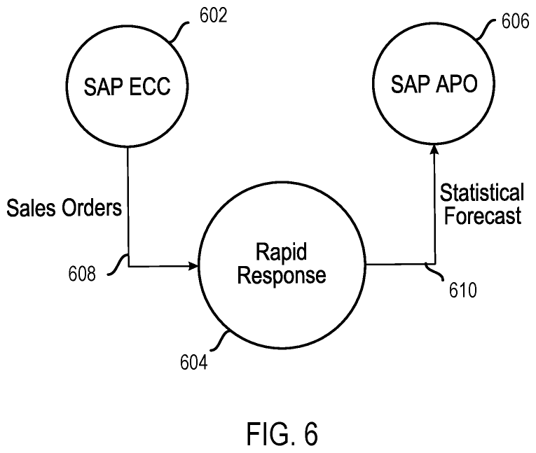

FIG. 6 shows an example of a data flow model, in accordance with some embodiments. As illustrated, the data flow model includes computer systems 602, 604, 606. The data flow model further indicates data flows 608, 610 between the computer systems. In one example, the data flow model is data flow model 206. In one example, the data flow model is a system context diagram.

For example, system 602 is a source and system 604 is a destination corresponding to data flow 608. For example, system 604 is a source and system 606 is a destination corresponding to data flow 610.

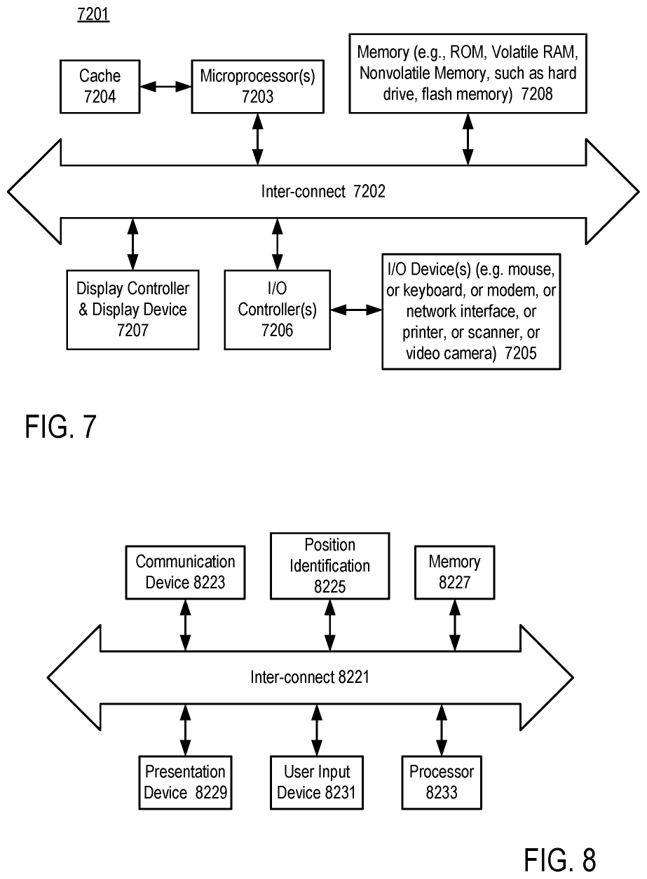

FIG. 7 shows a block diagram of a computing device, which can be used in various embodiments (e.g., computing device 104; computer system 108, 112; servers 116, 118, 120). While FIG. 7 illustrates various components, it is not intended to represent any particular architecture or manner of interconnecting the components. Other systems that have fewer or more components may also be used.

In FIG. 7, computing device 7201 includes an inter-connect 7202 (e.g., bus and system core logic), which interconnects a microprocessor(s) 7203 and memory 7208. The microprocessor 7203 is coupled to cache memory 7204 in the example of FIG. 7.

The inter-connect 7202 interconnects the microprocessor(s) 7203 and the memory 7208 together, and also interconnects them to a display controller and display device 7207 and to peripheral devices such as input/output (I/O) devices 7205 through an input/output controller(s) 7206. Typical I/O devices include mice, keyboards, modems, network interfaces, printers, scanners, video cameras and other devices which are well known in the art.

The inter-connect 7202 may include one or more buses connected to one another through various bridges, controllers and/or adapters. In one embodiment the I/O controller 7206 includes a USB (Universal Serial Bus) adapter for controlling USB peripherals, and/or an IEEE-1394 bus adapter for controlling IEEE-1394 peripherals.

The memory 7208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a solid-state drive, magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the computing device. A non-volatile memory that is remote from the computing device, such as a network storage device coupled to the computing device through a network interface such as a modem or Ethernet interface, can also be used.

In one embodiment, a computing device as illustrated in FIG. 7 is used to implement a user terminal or a mobile device on which an application (e.g., scanning component 218 and/or rendering component 204) is installed. A user terminal may be in the form, for example, of a laptop or notebook computer, or a personal desktop computer.

In some embodiments, one or more servers can be replaced with the service of a peer-to-peer network of a plurality of data processing systems, or a network of distributed computing systems. The peer to peer network, or a distributed computing system, can be collectively viewed as a computing device.

Embodiments of the disclosure can be implemented via the microprocessor(s) 7203 and/or the memory 7208. For example, the functionalities described can be partially implemented via hardware logic in the microprocessor(s) 7203 and partially using the instructions stored in the memory 7208. Some embodiments are implemented using the microprocessor(s) 7203 without additional instructions stored in the memory 7208. Some embodiments are implemented using the instructions stored in the memory 7208 for execution by one or more general purpose microprocessor(s) 8203. Thus, the disclosure is not limited to a specific configuration of hardware and/or software.

FIG. 8 shows a block diagram of a computing device (e.g., a mobile device of a user, or a user terminal), according to one embodiment. In FIG. 8, the computing device includes an inter-connect 8221 connecting the presentation device 8229, user input device 8231, a processor 8233, a memory 8227, a position identification unit 8225 and a communication device 8223.

In FIG. 8, the position identification unit 8225 is used to identify a geographic location. The position identification unit 8225 may include a satellite positioning system receiver, such as a Global Positioning System (GPS) receiver, to automatically identify the current position of the computing device.

In one example, collected tag data includes a geographic location of a computing device on which a process runs.

In FIG. 8, the communication device 8223 is configured to communicate with a server to provide data, including parameter data (e.g., values for manufacturing specifications obtained from a QR code of a component to be used to make a physical product). In one embodiment, the user input device 8231 is configured to receive or generate user data or content. The user input device 8231 may include a text input device, a still image camera, a video camera, and/or a sound recorder, etc.

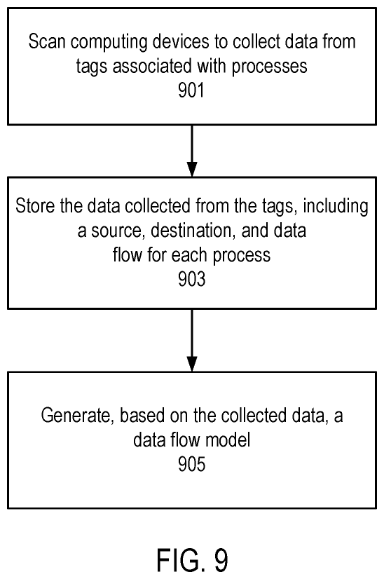

FIG. 9 shows a method for rendering a data flow model based on data collected from tags associated with processes running on various computer systems, in accordance with some embodiments. For example, the method of FIG. 9 can be implemented in the system of FIG. 1 or 2.

The method of FIG. 9 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 9 is performed at least in part by one or more processing devices (e.g., a processor of computer system 202).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 901, computing devices are scanned to collect data from tags associated with processes that run on the computing devices. In one example, computing device 104 runs a job to collect tag data from computer systems 108, 112 and/or servers 116, 118, 120.

At block 903, the data collected from the tags is stored. The collected data includes a source, destination, and data flow for each process. In one example, the collected data is tag data 210. In one example, the collected data is stored as records 304, 306, 308 in database 302.

At block 905, the collected data is used to generate a data flow model. In one example, the data flow model is data flow model 206. In one example, the data flow model is a system context diagram. In one example, the generated data flow model is sent to manufacturing server 406 and used to control machines 412, 414.

In one embodiment, a system comprises: a data repository (e.g., 106, 208, 302) configured to store data collected from a plurality of networked computing devices; and a rendering component (e.g., 204) configured to generate a data flow model. The system further comprises at least one processing device (e.g., microprocessor 7203, processor 8233) configured to: query each of the plurality of networked computing devices to determine data flows by collecting data from tags associated with processes that execute on the computing devices, wherein each process is associated with a respective tag, the tag including a source, a destination, and a corresponding data flow; store, in the data repository, the data collected from the tags (e.g., tag data 210), wherein the collected data includes the source, destination, and data flow for each respective process; and generate, using the rendering component and based on the collected data from the tags, the data flow model (e.g., 206).

In one embodiment, each respective data flow corresponds to a transfer of data from a database at the corresponding source to the corresponding destination.

In one embodiment, each respective data flow includes at least one of a type of data, or a data structure.

In one embodiment, the source is a source system from which the respective process receives data, and the destination is a destination system to which the respective process sends data.

In one embodiment, the data flow model is a system context diagram.

In one embodiment, the data flow model indicates data transfers among the networked computing devices.

In one embodiment, generating the data flow model comprises generating a graph or figure (e.g., system context diagram as illustrated in FIG. 6) for presentation on a display or printing as a hard copy.

In one embodiment, each computing device is configured in a respective computer system; each process is implemented by a stored procedure (e.g., Job 1 and Job 2 of FIG. 5) executed by the computing device on the respective computer system; the stored procedure is defined by source code (e.g., a file stored on the computer system), and the respective associated tag is non-functional data (e.g., a text comment in a source code file) associated with the source code.

In one embodiment, the processing device is further configured to control a machine that manufactures a product, wherein the data collected from the tags corresponds to the machine. In one example, the data to be collected is defined or selected based on the particular machine for which a generated data flow model will be used to control operation of the machine.

In one embodiment, the processing device is further configured to control manufacturing equipment using the data flow model.

In one embodiment, the processing device is further configured to include a link in the data flow model, wherein the link is associated with manufacturing data used to manufacture a product. In one example, data flow model 206 is generated by server 402 and includes a link (e.g., a hyperlink) to manufacturing data stored in database 410 and/or database 418.

In one embodiment, each data flow includes data associated with tracking movement of a physical object in a manufacturing or transport process.

In one embodiment, a first process of the processes is configured to: receive specifications for a product from a first computing device; and compare the specifications to process control data used to control a machine that manufactures the product. In one example, the specifications are received from database 410. In one example, the process control data is stored in database 418.

In one embodiment, the specifications include at least one of: materials used to manufacture the product; one or more components used to manufacture the product; or structural or functional requirements for the manufactured product.

In one embodiment, the processing device is further configured to: receive output data from a first process executing on equipment used to manufacture a product; select the networked computing devices to query based on the output data from the first process; and control the equipment using the data flow model. In one example, the output data is received from a first process executing on machine 412. Based on this output data, server 402 selects server 408 as one of the computing devices to query for collecting tag data. The generated data flow model is used to control machine 412 and/or 414.

In one embodiment, the processing device is further configured to: identify, based on the data flow model, a deficiency in a data flow required to manufacture a product; and in response to identifying the deficiency, remedy the deficiency. In one example, the deficiency is an insufficiency of data regarding information from a customer that specifies processing conditions to use in making physical product 416. Data flow model 206 is used to determine the missing information. In one example, a software update of a computer system (e.g., machine 412, 414) causes a change in data configuration that results in a mismatch to requirements of an application programming interface (API) of a process.

In one embodiment, the deficiency is remedied by at least one of retrieving additional data, or changing a configuration of equipment used to manufacture the product. In one example, the deficiency is remedied by sending a communication from server 402 that retrieves or requests the missing information from server 408 and/or another computing device. Server 402 causes the missing information to be sent to server 406 and/or machine 412, 414. In one example, the deficiency or mismatch is remedied by obtaining a software update and installing the update on a computer system.

In one embodiment, a system comprises: a scanning component (e.g., 218) configured to scan stored procedures associated with a plurality of computer systems, wherein each stored procedure includes at least one tag (e.g., 508, 510), and the tag comprises at least one source, at least one destination, and at least one data flow; a data repository configured to store data collected from the computer systems; and a rendering component configured to generate a data flow model based on the collected data.

The system further comprises a computing device configured to: scan, using the scanning component, each of the stored procedures to collect first data from the tags; store, in the data repository, the first data; and generate, using the rendering component and based on the first data, a data flow model. In one example, scanning component 218 scans jobs on server 408 and/or manufacturing server 406. The first data relates to processes used to make physical product 416. Rendering component 204 creates a data flow model that is downloaded to machine 412, 414.

In one embodiment, the data flow model is a system context diagram for the plurality of computer systems. In one example, the system context diagram illustrates source and destination systems connected by data flow arrows (e.g., FIG. 6).

In one embodiment, the scanning component is configured to scan the stored procedures at defined time intervals. In one example, a job on computer system 202 executes every day or every 60 minutes to scan stored procedures.

In one embodiment, each stored procedure is defined by source code, and the respective tag is non-functional data associated with the source code (e.g., FIG. 5).

In one embodiment, the plurality of computer systems is used for manufacturing a product, and the computing device is further configured to control a manufacturing machine using the data flow model. In one example, physical product 416 is made using machines 412, 414, which are controlled by data flow model 206.

In one embodiment, a method comprises: scanning a plurality of computing devices to collect data (e.g., tag data 210) from tags associated with processes that execute on the computing devices, wherein each process is associated with a respective tag, the tag including a source, a destination, and a data flow (e.g., 508, 510); storing the data collected from the tags, wherein the collected data includes the source, destination, and data flow for each respective process; and generating, based on the collected data, a data flow model. In one example, the collected data is stored as records 304, 306, 308 in database 302.

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system comprising:
a data repository configured to store data collected from a plurality of networked computing devices; and
at least one processing device configured to:
query each of the plurality of networked computing devices to determine data flows by collecting data from tags associated with processes that execute on the computing devices, wherein each process is associated with a respective tag, the tag including a source, a destination, and a corresponding data flow;
store, in the data repository, the data collected from the tags; and
generate, based on the collected data from the tags, a data flow model, the data flow model providing information regarding flows of data among the networked computing devices.

2. The system of claim 1, wherein each respective data flow corresponds to a transfer of data from a database at a source system to a destination system.

3. The system of claim 1, wherein each respective data flow includes at least one of a type of data, or a data structure.

4. The system of claim 1, wherein the source is a source system from which the respective process receives data, and the destination is a destination system to which the respective process sends data.

5. The system of claim 1, wherein the data flow model is a system context diagram.

6. The system of claim 1, wherein the data flow model indicates data transfers among the networked computing devices.

7. The system of claim 1, wherein generating the data flow model comprises generating a graph for presentation on a display or printing as a hard copy.

8. The system of claim 1, wherein:
each computing device is configured in a respective computer system;
each process is implemented by a stored procedure executed by the computing device on the respective computer system;
the stored procedure is defined by source code, and the respective associated tag is non-functional data associated with the source code.

9. The system of claim 1, wherein the processing device is further configured to control a machine that manufactures a product, wherein the data collected from the tags corresponds to the machine.

10. The system of claim 1, wherein the processing device is further configured to control manufacturing equipment using the data flow model.

11. The system of claim 1, wherein the processing device is further configured to include a link in the data flow model, wherein the link is associated with manufacturing data used to manufacture a product.

12. The system of claim 1, wherein each data flow includes data associated with tracking movement of a physical object in a manufacturing or transport process.

13. The system of claim 1, wherein a first process of the processes is configured to:
receive specifications for a product from a first computing device; and
compare the specifications to process control data used to control a machine that manufactures the product.

14. The system of claim 13, wherein the specifications include at least one of:
materials used to manufacture the product;
one or more components used to manufacture the product; or
structural or functional requirements for the manufactured product.

15. The system of claim 1, wherein the processing device is further configured to:
receive output data from a first process executing on equipment used to manufacture a product;
select the networked computing devices to query based on the output data from the first process; and
control the equipment using the data flow model.

16. The system of claim 1, wherein the processing device is further configured to:
identify, based on the data flow model, a deficiency in a data flow required to manufacture a product; and
in response to identifying the deficiency, remedy the deficiency.

17. The system of claim 1, wherein the deficiency is remedied by at least one of retrieving additional data or changing a configuration of equipment used to manufacture the product.

18. The system of claim 1, wherein the collected data includes the source, destination, and data flow for each respective process.

19. A system comprising:
a scanning component configured to scan stored procedures associated with a plurality of computer systems, wherein each stored procedure includes at least one tag, and the tag comprises at least one source, at least one destination, and at least one data flow;
a data repository configured to store data collected from the computer systems;
a rendering component configured to generate a data flow model based on the collected data; and
a computing device configured to:
scan, using the scanning component, each of the stored procedures to collect first data from the tags;
store, in the data repository, the first data; and
generate, using the rendering component and based on the first data, a data flow model.

20. The system of claim 19, wherein the data flow model is a system context diagram for the plurality of computer systems.

21. The system of claim 19, wherein the scanning component is configured to scan the stored procedures at defined time intervals.

22. The system of claim 19, wherein each stored procedure is defined by source code, and the respective tag is non-functional data associated with the source code.

23. The system of claim 19, wherein the plurality of computer systems is used for manufacturing a product, and the computing device is further configured to control a manufacturing machine using the data flow model.

24. A method comprising:
scanning a plurality of computing devices to collect data from tags associated with processes that execute on the computing devices, wherein each process is associated with a respective tag, the tag including a source, a destination, and a data flow;
storing the data collected from the tags, wherein the collected data includes the source, destination, and data flow for each respective process; and
generating, based on the collected data, a data flow model.
